(19) United States
(12) Patent Application Publication
(10) Pub. No.: US 2014/0291107 A1
(43) Pub. Date: Oct. 2, 2014

(54) CLUTCH PLATE

(71) Applicant: Caterpillar Inc., Peoria, IL (US)

(72) Inventors: Brian E. Lister, Edwards, IL (US); James S. Rice, Deer Creek, IL (US)

(21) Appl. No.: 14/302,796

(22) Filed: Jun. 12, 2014

(51) Int. Cl. F16D 13/64

(52) U.S. Cl. CPC F16D 13/64
USPC 192/107 R

(57) ABSTRACT

A clutch plate for a clutch assembly is provided. The clutch plate includes a body defining an outer circumference. A plurality of extensions projects radially from the outer circumference of the body. A first separating member is formed by bending a portion of at least one of the plurality of extensions along a first direction. The first separating member is configured to resiliently separate the clutch plate from an adjoining clutch plate of the clutch assembly along the first direction in a disengaged condition of the clutch assembly. A second separating member is formed by bending a portion of at least another of the plurality of extensions along a second direction. The second separating member is configured to resiliently separate the clutch plate from another adjoining clutch plate of the clutch assembly along the second direction in the disengaged condition of the clutch assembly.

### TECHNICAL FIELD

The present disclosure relates to a clutch plate, and more particularly a clutch plate for a multidisc clutch assembly.

### BACKGROUND

A multidisc clutch assembly typically includes clutch plates and friction plates. Each of the clutch plates and the friction plates are alternatively disposed in the clutch assembly. In an engaged condition of the clutch assembly, the clutch plates and the friction plates frictionally engage with each other, and rotate as a single unit. When the clutch assembly is disengaged, the clutch plates and the friction plates rotate independently of each other. However, the friction plates may tend to stick to the clutch plates or otherwise remain at least partially engaged with the clutch plates, even when the clutch assembly is disengaged. Further, drag losses in the multidisc clutch assembly may be related to a distance between adjacent clutch and friction plates. A shorter distance may result in increased drag losses within the multidisc clutch assembly.

U.S. published patent number 2013/0270054 discloses a multiplate clutch assembly for use in an automotive powertrain. The multiplate clutch assembly includes a first member, a second member, a plurality of first clutch plates attached to the first member and a plurality of second clutch plates attached to the second member. The first and second clutch plates are disposed alternatively with one another. At least two of the first clutch plates have separator portions that are configured to contact each other and provide a separation force therebetween.

### SUMMARY OF THE DISCLOSURE

In one aspect of the present disclosure, a clutch plate for a clutch assembly is provided. The clutch plate includes a body defining an outer circumference. A plurality of extensions project radially from the outer circumference of the body. Some of the plurality of extensions are configured to engage with a drive member of the clutch assembly. A first separating member is formed by bending a portion of at least one of the plurality of extensions along a first direction. Further, the first separating member is configured to resiliently separate the clutch plate from an adjoining clutch plate of the clutch assembly along the first direction in a disengaged condition of the clutch assembly. A second separating member is formed by bending a portion of at least another of the plurality of extensions along a second direction opposite to the first direction. The second separating member is configured to resiliently separate the clutch plate from another adjoining clutch plate of the clutch assembly along the second direction in the disengaged condition of the clutch assembly.

Other features and aspects of this disclosure will be apparent from the following description and the accompanying drawings.

### BRIEF DESCRIPTION OF THE DRAWINGS

FIG. 1 is a partial sectional view of a clutch pack, according to one embodiment of the present disclosure;

FIG. 2 is a perspective view of a clutch plate, according to one embodiment of the present disclosure;

FIG. 3 is a perspective view of a clutch plate, according to another embodiment of the present disclosure; and

FIG. 4 is a perspective view of a clutch plate, according to yet another embodiment of the present disclosure.

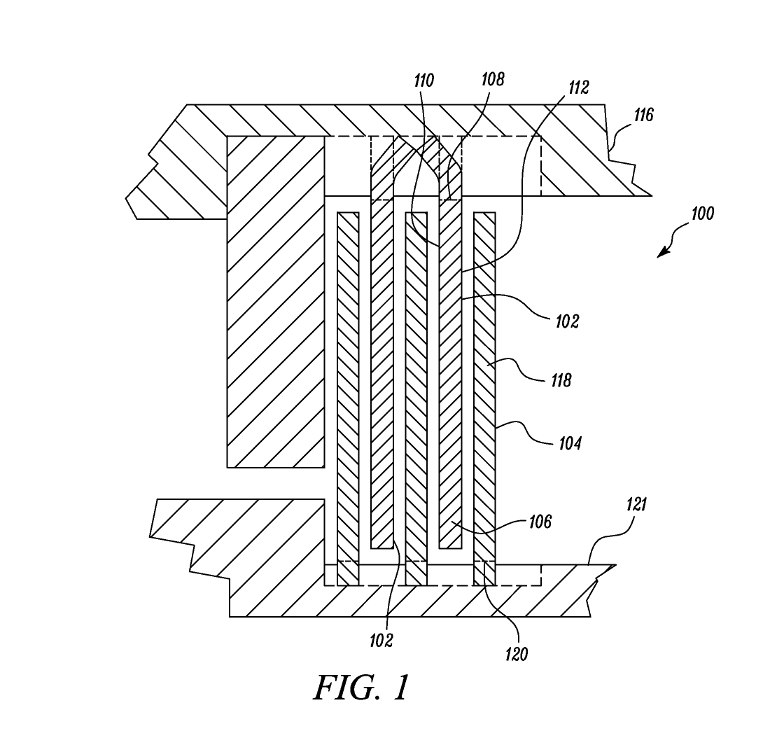

### DETAILED DESCRIPTION

Wherever possible, the same reference numbers will be used throughout the figures to refer to the same or the like parts. FIG. 1 illustrates a partial sectional view of a clutch pack 100, according to one embodiment of the present disclosure. A plurality of clutch plates 102 and a plurality of friction plates 104 may be disposed within the clutch pack 100 of a clutch assembly (not shown). The clutch assembly may be used in a drive system of a vehicle to transmit or disconnect power between a power source and ground engaging members of a vehicle. The ground engaging members may be, for example, wheels or tracks. The power source may be an internal combustion engine. The plurality of clutch plates 102 and friction plates 104 may be disposed in the clutch pack 100 such that each of the plurality of clutch plates 102 and friction plates 104 may be alternatively disposed adjacent to each other. For example, one clutch plate 102 may be disposed between two friction plates 104 and vice versa.

The clutch plate 102 may include a body 106 defining an outer circumference 108. The body 106 may define a first surface 110 and a second surface 112. The outer circumference 108 of the clutch plates 102 may be provided with a plurality of extensions configured to engage with a drive member 116 of the clutch assembly. The drive member 116 may be drivably coupled with the power source. The friction plates 104 may include a body 118 defining an inner circumference 120. The inner circumference 120 of the friction plates 104 may be configured to engage with a driven member 121 of the clutch assembly. The driven member 121 may be drivably coupled with the ground engaging members.

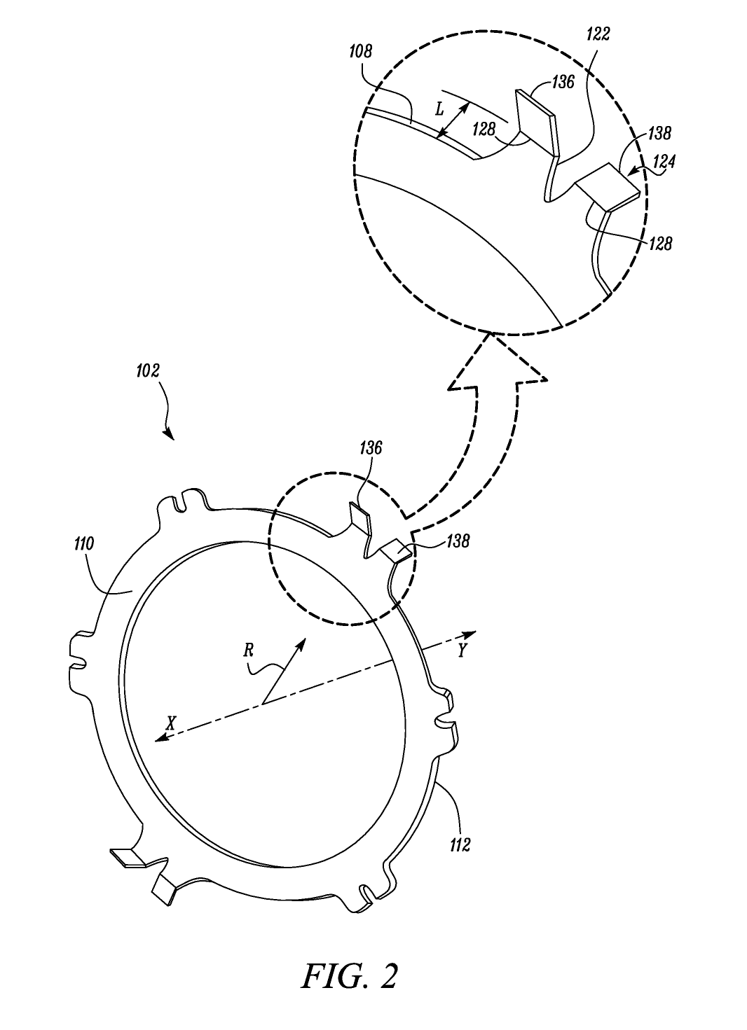

FIG. 2 shows a perspective view of the clutch plate 102, according to one embodiment of the present disclosure. The clutch plate 102 includes a plurality of extensions. One of the plurality of extensions 122 may define a length “L” that may extend between the outer circumference 108 of the clutch plate 102 and a distal end 128 along a radial direction “R” of the clutch plate 102. The clutch plate 102 includes a first separating member 136 formed by bending a portion of the extension 122 along a first direction X. The first direction X may be defined as an axial direction of the clutch plate 102 from the first surface 110 thereof. The portion of the extension 122 may extend from the distal end 128 of the extension 122. The first separating member 136 may be configured to resiliently separate the clutch plate 102 from the adjoining clutch plate 102 along the first direction X in a disengaged condition of the clutch assembly. In another embodiment, a second separating member 138 is formed by bending a portion of at least another of the plurality of extensions 124 along a second direction Y opposite to the first direction X. The second direction Y may be defined as an axial direction of the clutch plate 102 from the second surface 112 thereof. The second separating member 138 may be configured to resiliently separate the clutch plate 102 from another adjoining clutch plate 102 along the second direction Y in the disengaged condition of the clutch assembly. Referring to FIG. 2, it may be contemplated that although the first and second separating members 136, 138 are provided on extension 122 and 124, respectively, the separating members 136, 138 may be provided on other extensions of the clutch plate 102.

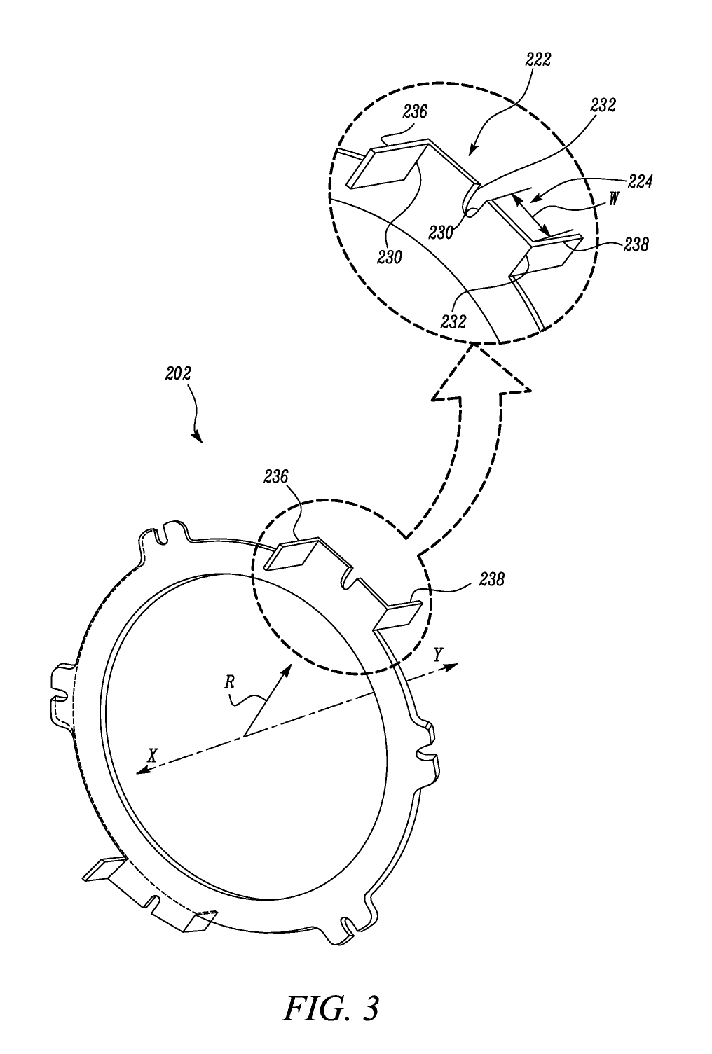

FIG. 3 is a perspective view of a clutch plate 202, according to another embodiment of the present disclosure. The clutch plate 202 includes a plurality of extensions. One of the plurality of extensions 222 may define a width “W” between a first lateral end 230 and a second lateral end 232. A first separating member 236 is formed by bending a portion of the extension 222 along the first direction X. The portion of the extension 222 may extend from the first lateral end 230 of the extension 222. The first separating member 236 may be configured to resiliently separate the clutch plate 202 from an adjoining clutch plate 202 along the first direction X in a disengaged condition of the clutch assembly. In another embodiment, a second separating member 238 is formed by bending a portion of another extension 224 along the second direction Y. The portion of another extension 224 may extend from the second lateral end 232 of another extension. The second separating member 238 may be configured to resiliently separate the clutch plate 202 from another adjoining clutch plate 202 along the second direction Y in the disengaged condition of the clutch assembly. It may be contemplated that, although the first and second separating members 236, 238 are provided on extensions 222 and 224, respectively, the separating members 236, 238 may be provided on other extensions of the clutch plate 202.

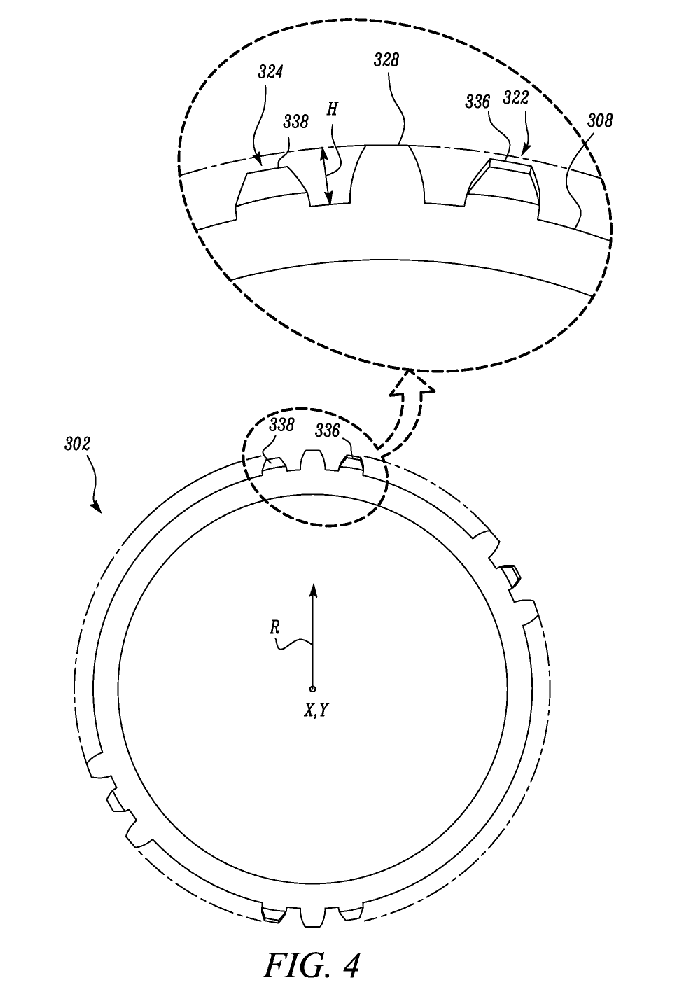

FIG. 4 is a perspective view of a clutch plate 302, according to yet another embodiment of the present disclosure. The clutch plate 302 may define an outer circumference 308. The outer circumference 308 may be provided with a plurality of extensions, including an extension 322 and another extension 324. The plurality of extensions may be in the shape of teeth. Some of the extensions may be configured to engage with the drive member 116 (shown in FIG. 1) of the clutch assembly. A height “H” of the extensions may be defined between the outer circumference 308 of the clutch plate 302 and a distal end 328 along the radial direction R of the clutch plate 302. The clutch plate 302 includes a first separating member 336 formed by bending a portion of the extension 322 along the first direction X. The first separating member 336 may be configured to resiliently separate the clutch plate 302 from the adjoining clutch plate 302 along the first direction X in a disengaged condition of the clutch assembly. In another embodiment, a second separating member 338 may be formed by bending a portion another extension 324 along the second direction Y. The second separating member 338 may be configured to resiliently separate the clutch plate 302 from another adjoining clutch plate 302 along the second direction Y in the disengaged condition of the clutch assembly.

### INDUSTRIAL APPLICABILITY

A typical multidisc clutch assembly includes clutch plates and friction plates. The clutch plates may be coupled with a drive member and the friction plates may be coupled with a driven member. In a disengaged condition of the clutch assembly, the clutch plates and the friction plates may rotate relatively and transmit a drag loss to a transmission system via the driven member. Thereby efficiency of the transmission is getting reduced.

The clutch plates 102, 202, 302 of the present disclosure includes first separating members 136, 236, 336 provided on the extensions 122, 222, 322, to resiliently separate the adjoining clutch plates 102, 202, 302, respectively, in the first direction X. The clutch plates 102, 202, 302 further includes second separating members 138, 238 338 provided on the extensions 124, 224, 324, to resiliently separate another adjoining clutch plates 102, 202, 302, respectively, in the second direction Y. Thus, in the disengaged condition of the clutch assembly, the separating members 136, 236, 336, 138, 238, 338 may ensure increased separation between adjoining clutch plates 102, 202, 302, thereby reduce drag losses and hence increase transmission efficiency. During the engaged condition of the clutch assembly, the separating member 136, 236, 336, 138, 238, 338 provides a gradual engagement between the adjoining clutch plates 102, 202, 302.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A clutch plate for a clutch assembly, the clutch plate comprising:
a body defining an outer circumference;
a plurality of extensions projecting radially from the outer circumference of the body, wherein some of the plurality of extensions is configured to engage with a drive member of the clutch assembly;
a first separating member formed by bending a portion of at least one of the plurality of extensions along a first direction, wherein the first separating member is configured to resiliently separate the clutch plate from an adjoining clutch plate of the clutch assembly along the first direction in a disengaged condition of the clutch assembly; and
a second separating member formed by bending a portion of at least another of the plurality of extensions along a second direction opposite to the first direction, the second separating member configured to resiliently separate the clutch plate from another adjoining clutch plate of the clutch assembly along the second direction in the disengaged condition of the clutch assembly.
